(19) United States
(12) Patent Application Publication
(10) Pub. No.: US 2016/0023404 A1
(43) Pub. Date: Jan. 28, 2016

(54) THREE-DIMENSIONAL MANUFACTURING, FABRICATING, FORMING, AND/OR REPAIRING APPARATUS AND METHOD

(71) Applicant: STEPHEN RAYMOND ANDERSON, YORKTOWN HEIGHTS, NY (US)

(72) Inventor: STEPHEN RAYMOND ANDERSON, YORKTOWN HEIGHTS, NY (US)

(21) Appl. No.: 14/806,533

(22) Filed: Jul. 22, 2015

Related U.S. Application Data
(60) Provisional application No. 62/029,404, filed on Jul. 25, 2014.

(51) Int. Cl. B29C 67/00; G05B 19/4099

(52) U.S. Cl. CPC B29C 67/0088; G05B 19/4099; B33Y 50/02

(57) ABSTRACT

An apparatus, including a fabrication platform; at least one fabrication tool capable of forming, adding to, or subtracting from, an object of manufacture or a component thereof; a three-dimensional guide system for guiding a movement of the at least one fabrication tool; at least one sensor for determining a distance or a depth of a point or point of or on the object of the manufacture or the component, the fabrication platform, the at least one fabrication tool, or the three-dimensional guide system; a controller capable of controlling a position or an operation of the fabrication platform, the at least one fabrication tool, or the three-dimensional guide system; a user input device for inputting an instruction, data, or information, into the apparatus; and a database for storing an instruction, data, or information, for manufacturing, fabricating, forming, or repairing, an object of manufacture or a component.

### RELATED APPLICATIONS

This application claims the benefit of the priority of U.S. Provisional Patent Application Ser. No. 62/029,404, filed Jul. 25, 2014, and entitled “THREE-DIMENSIONAL MANUFACTURING, FABRICATING, FORMING, AND/OR REPAIRING APPARATUS AND METHOD”, the subject matter and teachings of which are hereby incorporated by reference herein in their entirety.

### FIELD OF THE INVENTION

The present invention pertains to a three-dimensional (“3D”) manufacturing, fabricating, forming, and/or repairing apparatus and method and, in particular, the present invention pertains to a three-dimensional manufacturing, fabricating, forming, and/or repairing apparatus and method which can be scaleable and which can be utilized in and for a wide variety of applications.

### BACKGROUND OF THE INVENTION

Three-dimensional (3D) printers have long been used in industrial manufacturing applications. In recent years, prices have dropped such that hobbyists and other consumers have been able to purchase or make commercial 3D printers.

However, another barrier for effective public use of such devices are the skills of the operator. Without the proper mechanical and electrical know-how, the maintenance and the proper operation of 3D printers can be a daunting task.

3D printer systems and other fabrication systems are generally restricted to a single method of fabrication and/or to a single material with which to fabricate.

### SUMMARY OF THE INVENTION

The present invention pertains to a three-dimensional manufacturing, fabricating, forming, and/or repairing apparatus and method and, in particular, the present invention pertains to a three-dimensional manufacturing, fabricating, forming, and/or repairing apparatus and method which can be scaleable and which can be utilized in and for a wide variety of applications, which overcomes the shortfalls of the prior art.

The present invention can include calibration and troubleshooting systems which can help be utilized regardless of the skill level of a potential device operator, and ultimately may save time and materials in the event of a failure or error. The present invention also increases the utility and range of functions the device can perform, allowing for the manufacture of more complex objects.

The present invention can include a sensor or a sensor array to aid in device calibration, which is can be useful for providing for a more time-efficient and simplified access to the device.

The present invention can include a sensor or a sensor array which can be used to stop or to otherwise repair the device and the object to be manufactured in the event of a failure or error.

The present invention can also include a database and/or computing software which can be utilized in order to make the device more straightforward and easier to command and which requires less computer knowledge from a potential operator.

The present invention can include a robust mechanical design and suite of tools which can be utilized to allow for complex and/or multiple step manufacturing, and the manufacture of objects which are not presently capable of being created by a 3D printer alone.

The present invention can also include a mechanical design that protects fabrication tools from damage that would otherwise result in costly and time-consuming repairs which may be beyond the operational skill of a user.

The present invention can be scaled to meet a wide variety of applications and can include commercial, industrial, and military uses and applications.

### BRIEF DESCRIPTION OF THE DRAWINGS

In the Drawings:

FIG. 1 illustrates a preferred embodiment of the apparatus of the present invention;

FIG. 2 illustrates certain components of another preferred embodiment of the apparatus of the present invention in more detail, including an exploded view of the parts or components of same;

FIG. 3 illustrates a detailed view of an exemplary fabrication tool and sheath of the apparatus of the present invention which are mounted within an articulated arm;

FIG. 4 illustrates a series of steps of a simple example of error correction in the apparatus of the present invention;

FIG. 5 illustrates a preferred embodiment method of using the apparatus of the present invention for performing repair of an existing object, in flow diagram form; and

FIG. 6 illustrates a preferred embodiment method of using the apparatus of the present invention for performing a manufacture of a new object, in flow diagram form.

### DESCRIPTION OF THE PREFERRED EMBODIMENTS

The present invention pertains to a three-dimensional manufacturing, fabricating, forming, and/or repairing apparatus and method and, in particular, the present invention pertains to a three-dimensional manufacturing, fabricating, forming, and/or repairing apparatus and method which can be scaleable and which can be utilized in and for a wide variety of applications.

Applicant hereby incorporates by reference herein the subject matter and teachings of U.S. Provisional Patent Application Ser. No. 62/029,404, filed Jul. 25, 2014, and entitled “THREE-DIMENSIONAL MANUFACTURING, FABRICATING, FORMING, AND/OR REPAIRING APPARATUS AND METHOD”, the subject matter and teachings of which are hereby incorporated by reference herein in their entirety.

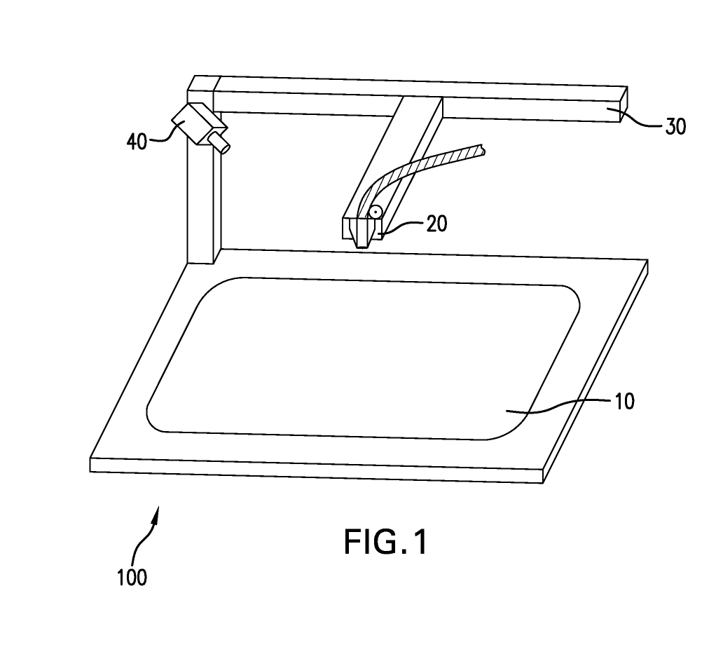

FIG. 1 illustrates a preferred embodiment of the apparatus 100 of the present invention. In a preferred embodiment, the apparatus 100 includes a generic additive 3D printer, which includes a fabrication platform 10, a fabrication tool 20, and a truss system 30 which allows the fabrication tool 20 to move in three dimensions. That is, in a preferred embodiment, one or more computer controlled motors manipulate the structure of the truss system 30 to move the fabrication tool 20 up/down, left/right, and/or forward/backward.

The fabrication platform 10 is and/or defines the area upon which an object is fabricated. In operation, it can be useful to prepare this fabrication platform 10 with a layer of painter's tape, etc. so as to more easily allow the finished object to be removed from the fabrication platform 10 manually.

In a preferred embodiment, the fabrication tool 20 is typically an “extruder,” which is a housing with a system of gears which feeds a length of material (plastic) past a heated element (which softens the material) before extruding the molten material onto the fabrication platform 10 or base or other material. It is important to note that the fabrication tool 20 can also be implemented with or by any other suitable device.

The truss system 30, in a preferred embodiment is, or can be implemented by or with, a set of motors, gears, belts and any supporting structure which moves the fabrication tool 20 in space.

Each motor which is utilized in the preferred is or can be computer controlled. Thus the computer controls the feed of material, the movement of the truss system 30, and may also control the circuitry which enables or disables the heating element.

In a preferred embodiment, other printers, such as those used or employed as a subtractive router can also be utilized in conjunction with the apparatus 100 of the present invention. In such and embodiment, a pre-existing amount of material (such as for instance, a block of metal) is placed or mounted to the fabrication base, and the fabrication tool 20 is instead a drill or a router which removes material in a material subtractive manner or fashion.

In another preferred embodiment, other generic printers which can be configured in or as an additive device can be utilized in conjunction with the apparatus 100 of the present invention. In this manner, the apparatus 100 can be utilized with these additive printers to build up or build upon metals by depositing a metal powder and by melting that powder with a system of lasers and mirrors. This method is known as and defined herein as “laser sintering.”

The apparatus 100 of the present invention is also includes at least one or more, or any number of, time-of-flight photometers or any other sensor 40 or a network of sensors 40 which are capable of discerning depth, either intrinsic to the sensor 40, and/or when data obtain with or from the sensor 40 is combined and processed at a computer. In FIG. 1, one such sensor 40 is shown mounted to the truss system 30.

With reference to FIG. 1, the Sensor 40, in a preferred embodiment, may be mounted on the truss system 30, on the fabrication platform 10, on or with the fabrication tool 20, or is mounted external from or to the generic printer system, or any other configuration such that the sensor 40 can gather information of or from the generic printer system and the object which is to be or is being fabricated.

In the preferred embodiment, the sensor 40 is attached to a computer which is the same as the computer which offers or provides motor control. In another preferred embodiment, however, the sensor 40 may instead be associated with another computer or computer system, as long as data from the sensor 40 may be connected to the motor-control computer either directly or through a network.

In the preferred embodiment, the motor control computer is connected to or linked to or with the Internet such that the computer may access a database which contains the desired, or any desired, build or fabrication instructions. The apparatus 100 can also function as a stand-alone device and without any Internet connection, as the instructions could be stored in or on and/or can be obtained from a database which can be local to the computer or any data can be otherwise delivered to the computer (for example, such as by manual input by an operator).

In the preferred embodiment. the database of build, fabrication, and/or assembly instructions is or can be populated by sensor 40 data, by third party data, and/or by user input. In the preferred embodiment, third party users may play a computer game that allows them to construct 3D objects. In a preferred embodiment, the program utilized can learn, from user interaction, on how best to perform certain build or fabrication tasks concerning objects and parts. The computer can then synthesize from the desired outcome provided by the user (the task), the sensor 40 information (what is available to work with, and which can also be provided by the user), and data from the database (including third party instructions from the game, previous projects, previous steps learned by the computer, etc.) a set of instructions for the apparatus 100 to follow to create an object.

The truss system 30, in another preferred embodiment, can be replaced by an articulated robotic arm 50, whose use in fabrication is ubiquitous with specialized applications in automotive manufacture and other fabrication processes. Both the truss system 30 and the articulated arm 50 can be built or fabricated from or using computer controlled motors, gears, belts, and/or any supporting structure(s). One advantage of the articulated arm 50 is its capability to approach the build or the fabrication process from multiple angles, whereas the truss system 30 is generally restricted to a ‘top-down’ approach on the simplest of devices. For this preferred embodiment of the present invention, the articulated arm 50 should contain a mechanism for manipulating objects (such as a grabbing device) as well as the fabrication tool 20 or multiple fabrication tools 20 of FIG. 1.

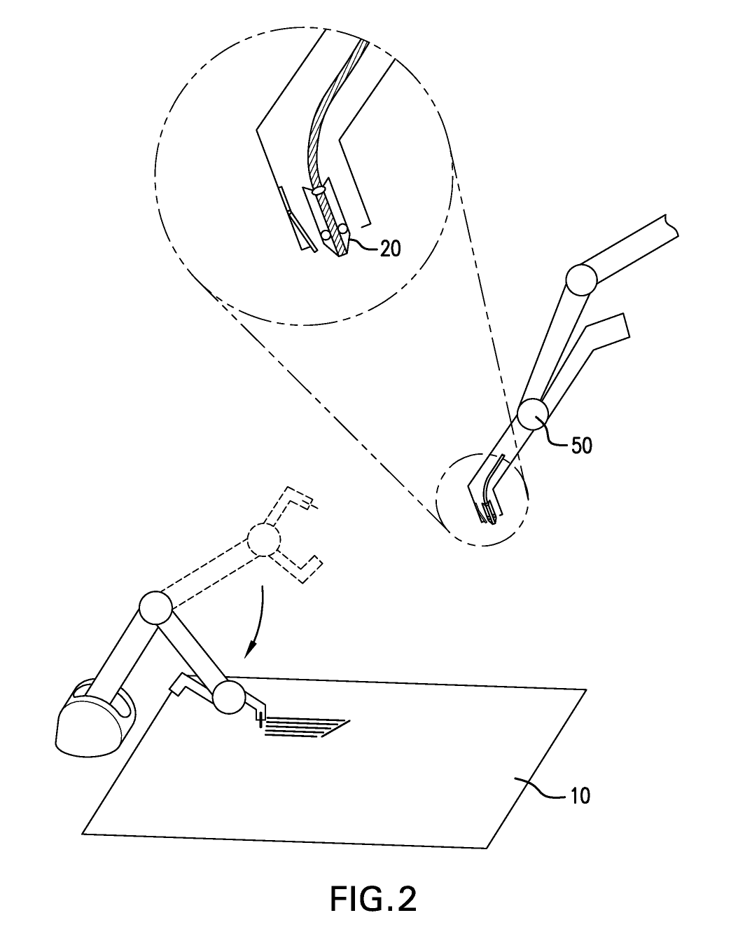

FIG. 2 illustrates certain components of another preferred embodiment of the apparatus 100 of the present invention in more detail, including an exploded view of the parts or components of same. FIG. 2 depicts how both the grabbing device and fabrication tools 20 may be incorporated together into a single arm 50. Such a “multi-tool” approach may decrease cost by reducing the need for multiple, and specialized, articulated arms 50. FIG. 2 further illustrates how the arm 50 may be manipulated in order to expose an active fabrication tool 20 to the fabrication platform 10 while keeping other fabrication tools 20 out of the way. Not shown in FIG. 2 is the sensor 40, which can be mounted in any configuration which gives it the capability to sense the fabrication area consisting of the fabrication platform 10, the arm 50, and at least, but not limited to, the volume of space accessible by the arm 50 and the fabrication tools 20.

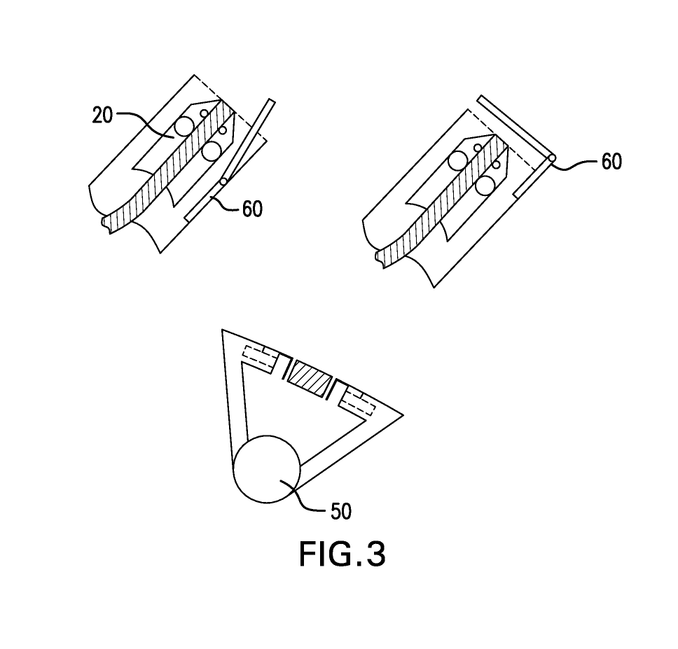

FIG. 3 illustrates a detailed view of an exemplary fabrication tool and sheath of the apparatus 100 of the present invention which are mounted within an articulated arm. FIG. 3 further includes a detailed view of the end of the grabbing device, wherein a retractable sheath 60 may be retracted so as to enable a fabrication tool 20 inside the arm 50 to operate. The sheath 60 otherwise protects the often fragile and/or expensive fabrication tools 20 from damage while the grabber arm 50 is in operation.

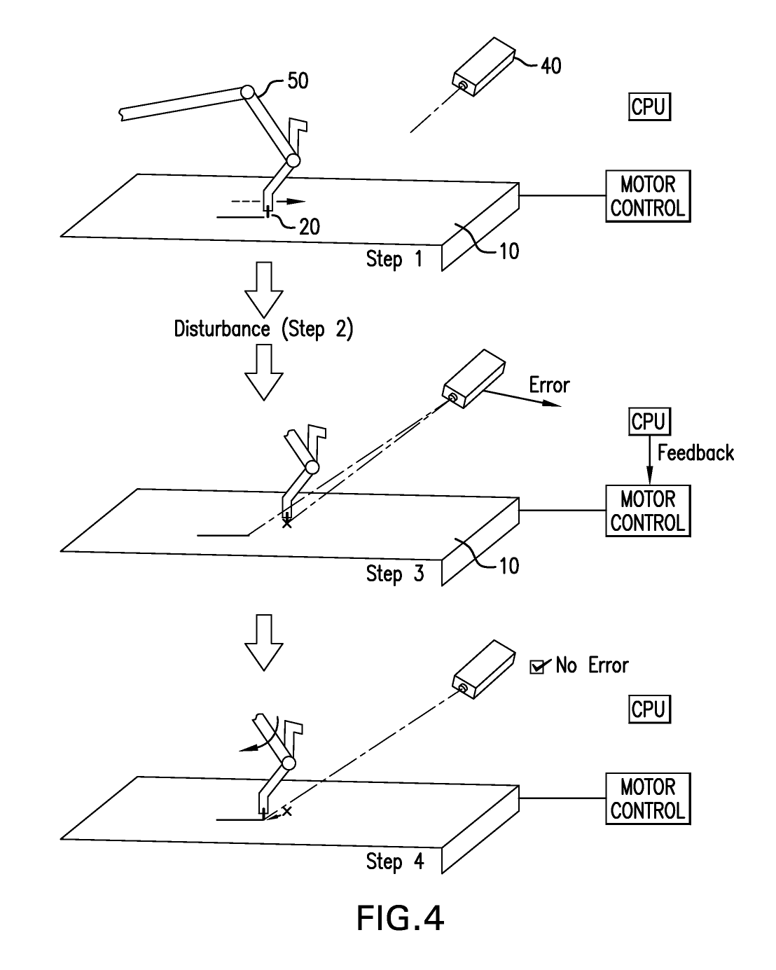

FIG. 4 illustrates a series of steps of a simple example of error correction in the apparatus 100 of the present invention. FIG. 4 illustrates a multiple step operation of the articulated arm 50 in conjunction with the sensor 40 suite realizing in-operation dynamic calibration. In or during step 1, computer control sets the articulated arm 50 with operating fabrication tool 20 to extrude a simple line (as and for an example). In or during step 2, some disturbance to the device occurs, which results in the articulated arm 50 being removed from its desired position beginning in or during step 3. In or during step 3, the sensor 40 detects the true location of the partial line, the fabrication platform 10, and the articulated arm 50, and relays that data to the computer. Error between the true location of the articulated arm 50 in space and its desired location is detected, and the computer relays corrective information to the motor control. If necessary, the device may also correct for building errors at this point, using subtractive methods to remove material incorrectly placed and additive methods to fix subtractive errors. In or during step 4, motor control has returned the articulated arm 50 to its desired location relative to the fabrication platform 10 and partial line, and normal operation may resume.

Careful calibration is usually required of an amateur user in order for the device to properly work. However, the time-consuming and difficult nature of keeping the truss system 30 aligned with the fabrication platform 10, among other issues, forms a barrier-to-entry and a barrier-to-use the device.

With the integration of the sensor 40 suite with a generic 3D printer, the initial manual calibration can be bypassed by a computer-implemented calibration method, wherein the sensor 40 suite scans the fabrication platform 10 (and potentially the truss system 30 including fabrication tool(s) 20 and sensor(s) 40) and can generate a 3D map of the system. With this data, orientation issues such as a skewed fabrication base, truss system 30, fabrication tool 20 or sensor 40, may be corrected automatically or may generate instructions to aid or instruct manual calibration. This may make 3D printer systems more accessible to a wider number of users.

Yet another issue facing printing systems occurs in and during operation, when a mechanical failure or software glitch can cause catastrophic results for the printed object. As and for an example, a gear may skip a tooth, causing part of the truss system 30 to become misaligned. Under normal operation of a prior art generic 3D printer, the device continues following its build program which assumes the truss is in the correct position. As a result, the rest of the build occurs skewed to the pre-failure build, and a defective product is created, resulting in a waste of resources (material consumed and energy to run the device), and time (complexity of a build as well as size greatly increases the time required to complete a build). This is generally remedied by having an operator watch or monitor the device as the build progresses in order to stop the machine when a failure occurs; however this is a disadvantageous waste of manpower.

The integrated sensor 40 suite and software allows for autonomous building or fabrication that does not require operator or human monitoring. When a failure occurs, the apparatus 100 may stop the build and send an alert to an operator (presumably at work somewhere else) or use the sensor 40 suite to self-diagnose, self-repair, and/or self-correct, the failure in order to resume proper operation without the need for a human operator.

The invention also has other unique uses in 3D printer fabrication. By combining sensor 40 information of what exists on the fabrication platform 10 or near the device with desired instructions and the articulated arm 50 platform, the repair of an object may be facilitated.

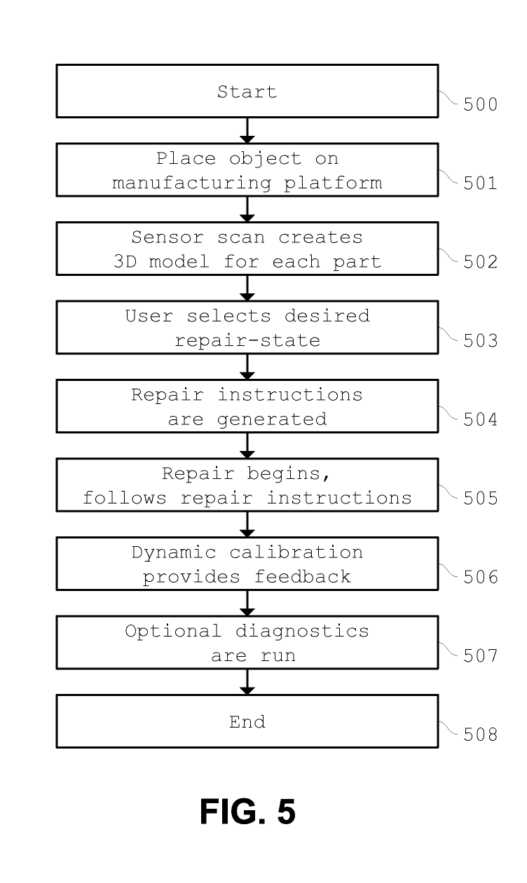

As and for an example, the steps taken by the apparatus 100 to repair a broken plate are listed below, and more generally in FIG. 5. FIG. 5 illustrates a preferred embodiment method of using the apparatus 100 of the present invention for performing repair of an existing object, in flow diagram form. The operation of the apparatus 100 begins at step 500.
1. At step 501, place plate shards on machine platform.
2. At step 502, the apparatus 100 scans the shards, creating a 3D model for each.
3. At step 503, select the template to repair to (for the desired or selected repair) (3D model of plate supplied by user, manufacturer, third party software/database).
4. At step 504, assembly instructions are synthesized from input by user, manufacturer, and/or third party, especially when given the shard 3D models and template and use (super)computing or crowd sourced methods to determine assembly steps.
5. At step 505, repair begins.
6. At step 506, computer vision dynamic calibration is activated, and provides feedback while the repair instructions are executed. It is envisioned that the repair instructions specific to this example of a broken plate proceed as follows:
   a. shards are placed or held next to each other;
   b. the extruder head deposits adhesive/resin/epoxy at boundary, which is guided by assembly instructions and computer vision dynamic calibration;
   c. if necessary, adhesive/resin/epoxy is activated by lasers (photo-curing process), heat (heat-curing process), chemical, etc.;
   d. the process repeats until all shards are rejoined (as per assembly instructions);
   e. additive component fills in voids of the plate where shards were unrecoverable/unsalvageable;
   f. subtractive component (chisel, sandpaper, water or sand blasting, router, or a fine finishing device) removes excess adhesive/resin/epoxy;
   h. if necessary, plate is prepared for a new protective coating;
   i. if necessary, plate is coated in a new protective coating;
7. At step 507, which can be an optional step, optional diagnostics are run.
8. At step 508, the repair process ends.

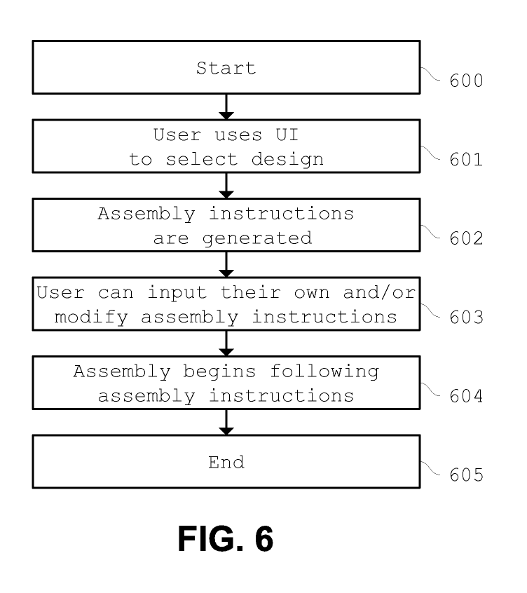

Further, the combined sensor 40 and the articulated arm 50 system allow for the assembly of a multiple-part object. FIG. 6 illustrates a preferred embodiment method of using the apparatus 100 of the present invention for performing a manufacture of a new object, in flow diagram form. The general steps for this method are listed with some detail below, and more generally in FIG. 6. The operation of the apparatus can begin at step 600.
1. At step 601, the user uses the User Interface to explore a pre-populated database of objects (with built-in search) and can select design and/or transact payment for pay-to-manufacture information/objects and/or import user's own design.
2. At step 602, assembly instructions are generated from the design (a “part-assembly file” can be generated by the computer) where generation can be aided or realized by crowd-sourcing methods, supercomputing methods (especially through a service that connects users with a supercomputing-capable company).
3. At step 603, the user can input their own and/or modify assembly instructions.
4. At step 604, assembly begins following assembly instructions which may involve any and/or all of the following:
   a. Part creation through additive, subtractive processes;
   b. Part manipulation in space;
   c. Part assembly into subsystems and systems and objects;
   d. Dynamic Calibration by sensors ensures assembly proceeds as planned;
   e. Dynamic Calibration feeds-back to assembly instructions necessary information to perform certain assembly tasks which can include joining or attaching parts together, and/or correcting defects or deviations from assembly instructions;
   f. Dynamic Calibration sensors may participate in post-manufacture diagnostics to determine, in a preferred embodiment, if the assembled object is working as planned. As and for and example, when a computer chip is part of the manufactured object, diagnostics can confirm the system turns on and operates appropriately.
5. At step 605, the assembly process ends.

This allows for the construction of objects which would be impossible to produce through any one process alone (for example, using only extrusion methods, or building an object of multiple materials, building an object with moving parts, etc.).

Since a plurality of tools may be incorporated into the articulated arm 50, many processes may be carried out by the apparatus 100, including operation for effectuating additive manufacturing, subtractive manufacturing, laser sintering, sanding, priming, painting, drilling, cutting, welding, and/or joining, etc.

Since the articulated arms 50 may manipulate objects and the sensors 40 can “see” those objects in space, manufactured objects may further be diagnosed and tested for their proper operation by the apparatus 100 once assembled.

The apparatus 100 may incorporate pre-assembled subsystems (such as circuit boards) with other assembled parts in order to manufacture relatively complex objects. The development of sophisticated fabrication tools 20 capable of laying down circuitry would be an advantageous addition to the suite of fabrication tools 20 described herein.

The apparatus 100 can also be utilized without a fabrication platform 10 altogether, in the sense that sensor 40 information of terrain combined with computer algorithms can establish a proper set of building instructions that could allow for construction on any suitable terrain, feature, landscape, or other object. In such a manner, the suitable terrain, feature, landscape, or other object can be treated as a fabrication platform 10.

The apparatus 100 of the present invention is and can be scalable; and could be made to work in or for a commercial application within the size of a desk, or smaller, or in or for industrial application and/or uses many times larger. For instance, fabrication tools 20 mounted on a large crane (a type of articulated arm 50) or large truss (a scaled version of the truss system 30 described herein), where the crane or truss is then computer controlled, allows for the fabrication of very large structures. Of great utility would be to make the system portable, either tow-able or mounted to a vehicle, such as, as and for an example, mounted within or on the bed or deck of a pickup-truck. As and for yet another example, the apparatus 100 could also be mounted to a ship, a satellite, a drone or other autonomous or remotely-piloted vehicle. Using the existing object repair method described and illustrated in FIG. 5, space junk may also be harvested and recycled into useful material in order to facilitate repair of other satellites or space-borne objects.

In another preferred embodiment, the apparatus 100 of the present invention can be utilized with or in connection with drones and other autonomous vehicles. It is known that some companies are creating drone-delivery methods, which can be used to transport critical supplies like medicine to otherwise-inaccessible locations. However, drones can be limited by their range, and their needing to refuel or recharge. A drone equipped with the apparatus 100 of the present invention may be used to construct structures in remote locations, by using either carried-materials or on-site materials or a combination of both. Such a drone could construct a drone-recharging station in a remote location using the new object manufacture method described and illustrated in FIG. 6, or could construct a firm foundation at the remote location on which to install a pre-built drone-recharging station. The newly-built remote drone-recharging station would allow the device-equipped drone to recharge itself and move to the next remote site, while the newly-built remote drone-recharging station can then be incorporated into the network of drone-recharging stations, extending the range of delivery drones, and the supplies they carry, in that region.

The benefits of these systems can likewise be extended to planetary exploration. Just as the device-equipped drones could be used for construction at remote locations on Earth, so too could this device be used to construct human habitation, scientific outposts, or similar drone-recharging stations at remote locations on other planets or celestial bodies, or can be used to effect the repair of such facilities.

Mobility is key for the military of any nation. In this regard, the apparatus 100 of the present invention can be utilized in connection or in conjunction with military equipment or in military applications. It is envisioned that the apparatus 100 of the present invention could be advantageous utilized to aid in the rapid construction of fortifications on a variety of terrain so as to better protect, and project the force of, military personnel. A plurality of apparatus-equipped drones could construct an advantageous fortification, or some component of a forward operating base. Just as airborne drones can also be utilized to project force without endangering pilots, an apparatus-equipped drone can be utilized to undertake dangerous tasks of constructing fortifications without endangering members of military engineering and construction personnel.

While the present invention has been described and illustrated in various preferred and alternate embodiments, such descriptions are merely illustrative of the present invention and are not to be construed to be limitations thereof. In this regard, the present invention encompasses all modifications, variations and/or alternate embodiments, with the scope of the present invention being limited only by the claims which follow.

What is claimed is:

1. A three-dimensional manufacturing, fabricating, forming, and/or repairing apparatus, comprising:
a fabrication platform;
at least one fabrication tool capable of forming, adding to, or subtracting from, an object of manufacture or a component thereof;
a three-dimensional guide system for guiding a movement of the at least one fabrication tool;
at least one sensor, wherein the at least one sensor determines a distance or a depth of a point or point of or on the object of manufacture or the component thereof, the fabrication platform, the at least one fabrication tool, or the three-dimensional guide system;
a controller capable of controlling a position or an operation of the fabrication platform, the at least one fabrication tool, or the three-dimensional guide system;
a user input device for inputting an instruction, data, or information, into the apparatus; and
a database for storing an instruction, data, or information, for manufacturing, fabricating, forming, or repairing, an object of manufacture or a component thereof,
wherein the controller processes information either input via the input device or stored in the database regarding an instruction, data, or information, and further wherein the controller controls an operation of the fabrication platform, the at least one fabrication tool, or the three-dimensional guide system, in performing a manufacturing, a fabricating, a forming, or a repairing, of an object of manufacture or a component thereof in response to the instruction, the data, or the information.

2. The apparatus of claim 1, further comprising:
an object manipulating tool, wherein the object manipulating tool manipulates, handles, moves, or orients, the object of manufacture or the component thereof.

3. The apparatus of claim 1, wherein the at least one sensor is a time-of-flight photometer.

4. The apparatus of claim 1, wherein the apparatus is scaleable to manufacture, fabricate, form, or repair, an object of manufacture or a component thereof having any size, shape, or type.

5. The apparatus of claim 1, wherein the object of manufacture or the component thereof is a micro-electronic circuit, an integrated circuit, or a nanostructure or a nano-device.

6. The apparatus of claim 1, wherein the apparatus is mounted on a desktop.

7. The apparatus of claim 1, wherein the apparatus is mounted on a surface.

8. The apparatus of claim 1, wherein the apparatus is mounted on, or a component of, a vehicle.

9. The apparatus or claim 8, wherein the vehicle is a motor vehicle or a marine vehicle.

10. The apparatus of claim 8, wherein the vehicle is a satellite, an aircraft, or a drone.

11. The apparatus of claim 8, wherein the vehicle is a manned vehicle.

12. The apparatus of claim 8, wherein the vehicle is a unmanned vehicle or a remotely controlled vehicle.

13. An apparatus, comprising:
at least one fabrication tool capable of forming, adding to, or subtracting from, an object of manufacture or a component thereof;
a three-dimensional guide system for guiding a movement of the at least one fabrication tool;
at least one sensor, wherein the at least one sensor determines a distance or a depth of a point or point of or on the object of manufacture or the component thereof, the at least one fabrication tool, or the three-dimensional guide system;
a controller capable of controlling a position or an operation of the at least one fabrication tool or the three-dimensional guide system;
a user input device for inputting an instruction, data, or information, into the apparatus; and
a database for storing an instruction, data, or information, for manufacturing, fabricating, forming, or repairing, an object of manufacture or a component thereof, wherein the controller processes information either input via the input device or stored in the database regarding an instruction, data, or information, and further wherein the controller controls an operation of the at least one fabrication tool or the three-dimensional guide system, in performing a manufacturing, a fabricating, a forming, or a repairing, of an object of manufacture or a component thereof in response to the instruction, the data, or the information.

14. The apparatus of claim 13, further comprising:
an object manipulating tool, wherein the object manipulating tool manipulates, handles, moves, or orients, the object of manufacture or the component thereof.

15. The apparatus of claim 13, wherein the at least one sensor is a time-of-flight photometer.

16. The apparatus of claim 13, wherein the apparatus is scaleable to manufacture, fabricate, form, or repair, an object of manufacture or a component thereof having any size, shape, or type.

17. The apparatus of claim 13, wherein the object of manufacture or the component thereof is a micro-electronic circuit, an integrated circuit, or a nanostructure or a nano-device.

18. The apparatus of claim 13, wherein the apparatus is mounted on a desktop.

19. The apparatus of claim 13, wherein the apparatus is mounted on a surface.

20. The apparatus of claim 13, wherein the apparatus is mounted on, or a component of, a vehicle.
